(19) United States
(12) Patent Application Publication
(10) Pub. No.: US 2015/0371501 A1
(43) Pub. Date: Dec. 24, 2015

(54) Suit-based three-card poker

(71) Applicant: Kathleen Nylund Jackson, Scituate, MA (US)

(72) Inventor: Kathleen Nylund Jackson, Scituate, MA (US)

(73) Assignee: Precedent Gaming, Inc., Scituate, MA (US)

(21) Appl. No.: 14/545,803

(22) Filed: Jun. 22, 2015

Related U.S. Application Data
(60) Provisional application No. 61/998,270, filed on Jun. 23, 2014.

(51) Int. Cl. G07F 17/32

(52) U.S. Cl. CPC G07F 17/3262; G07F 17/3293

(57) ABSTRACT

A method of playing a wagering card game on a table or electronic device is disclosed. The game is playable by at least a single player against a paytable, and utilizes at least three decks of traditional playing cards. At least three different cards are special cards, and at least one special card acts as a wild card. The amount of the special cards in a final hand determines a category in the paytable. Each category designates which special cards are wild, which hands are winning hands, and the corresponding pays. An Ante wager is required to play an initial hand, and an additional Draw wager is required if the play continues. The initial hand is considered a final hand if it is resolved as a win or loss. If the initial hand is not resolved, play continues until a final hand is resolved against the paytable.

### RELATED APPLICATION DATA

This Application claims priority from U.S. Provisional Patent Application Ser. No. 61/998,270, filed Jun. 23, 2014, and having the Title SUIT-BASED THREE-CARD POKER.

### BACKGROUND OF THE INVENTION

1. Field of the Invention

The present invention relates to variants of three-card poker games and side bets suitable for use in casinos, gaming establishments, interne sites or mobile devices as a felt table game, an electronic table game, an electronic machine game, or an electronic device game.

2. Background of the Art

Three-card poker is a popular poker variant, playable as a felt table game or electronic game. The popularity of three-card poker in the gaming industry is partially based on the fact that the game is simple to deal, and simple to play with easy rules and decision-making choices. In addition, it actually provides two games in one, which adds to the appeal.

The original and most commonly known three-card poker game (e.g., as described in U.S. Pat. No. 5,685,774, Webb) is played between at least one player and a dealer (or a virtual dealer hand in the case of electronic gaming). It comprises an Ante/Play game wherein the player is playing against the dealer to see who has the highest hand, and also a Pair Plus game where the player is wagering on whether or not he will be dealt a pair or better.

The game begins with each player making a wager in the Ante and/or Pair Plus betting circles at least equal to the table minimum. After all the players have made their bets, each player and the dealer is provided a three-card hand. If a player has made a bet on the Ante he must make their decision to fold or play after looking at their hand. If the player folds he forfeits his Ante wager. If the player wants to continue he must make an additional bet in the Play circle equal to his Ante bet. After all the players have made their decisions, the dealer will turn over his three-card hand. The dealer needs to “qualify” with a hand of Queen or higher for play to continue. If the dealer's hand does not contain a Queen or higher all players still active in the hand will be paid even money for their Ante wager and their bet on the Play will be returned to them. If the dealer's hand does qualify then his hand is compared to the player's hand. If the player's hand beats the dealer's hand, the player will be paid even money for his Ante and Play bets. If the dealer's hand beats the player's hand, the player loses both bets. The hands are ranked, from highest to lowest: Straight Flush, 3-of-a-Kind, Straight, Flush, Pair, High Card, and paid according to a first predetermined paytable. The Pair Plus wager is based only on whether the player's three-card hand has a Pair or higher. It doesn't matter if the dealer qualifies or even beats the player if the player has a bet on the Ante Game. If the player's hand has a Pair or better, the player wins. If it does not have at least a Pair, the player loses. The Pair Plus wager is paid according to a second paytable.

Prior art has taught numerous attempts to make three-card poker more exciting, stimulating and lucrative.

United States Patent Application No. 20140087799 (Yoseloff) provides a card game that is played against a pay table, wherein a player receives a partial hand that is preferably completed by community cards, but may be completed by cards dealt directly to a hand or a combination of cards dealt directly to a hand and at least one community card or wild card. After placement of an ante wager, each player will have an opportunity to place a game wager before receiving another card for the player's hand.

United States Patent Application No. 20140011570 (Nicely, et al.) discloses a three-card poker game that includes three cards being dealt to the player and the dealer, where all cards are dealt face-up. First, the player has an option to replace one card from the player's hand. Then, the dealer may replace one card according to a set of predetermined rules. The player makes a primary wager and an optional secondary wager. A primary award is provided if the player's hand beats the dealer's hand. If the secondary wager is placed, a secondary is award is provided if the either the player's or the dealer's hand is of a predetermined value.

United States Patent Application No. 20110163501 (Nguyen) describes a poker game in which the players are dealt three cards only, and are thereafter allowed to replace only one of the dealt cards to improve the rank of their hand. The game is played with at least three standard decks that are modified so that the modified decks contain only the ranks Ace, King, Queen, Jack and Ten in the suits of Spades, Hearts, Diamonds and Clubs. Players are not paid on wagers listed on a “paytable” of predetermined winning poker outcomes and corresponding odds. Instead, wagers are paid off at a ratio of one-to-one (1:1).

United States Application No. 20070290444 (Moses) describes a blackjack wagering game having a side bet bonus game wherein the side bet wager includes selecting at least one particular suit associated with a winning event in the side bet bonus game.

U.S. Pat. No. 8,579,292 (Salerno) discloses a method of playing a three-card draw poker game utilizing at least one deck of cards, wherein one card is a face down hold card for the players wherein low score wins. The game is played against the house with or without a hand.

U.S. Pat. No. 8,177,619 (Jackson) discloses a method of playing a wagering card game for a single player or a number of players using standard playing cards having a standard rank and involving standard poker hand rankings or modified rankings for Three Card Poker® games. The players play a draw poker game against a dealer's stud poker hand. Each player's hand contains fewer cards than the dealer's hand, but the game is resolved with final hands of equal amount of cards. After an Ante wager, a plurality of cards is dealt to each player, and a plurality of cards is dealt to the dealer. Following predetermined house rules, each player then may decide to execute one or more of the following options: Surrender, Fold, make a Play bet, make a Double Down bet, or make a Draw bet. The player may or may not discard a card to make the Draw bet. After all of the players' hands have been fully executed, the dealer then adds one or more additional face-up cards to his hand. Outcomes of a comparison of hands are determined by traditional poker rules and standard poker rankings. Wagers are then resolved according to a predetermined paytable.

U.S. Pat. No. 7,661,678 (Snow) discloses a method of playing a poker-type wagering game, wherein the method includes the steps of: a) placing a mandatory Ante bet to participate in a poker-type card game against a dealer hand; b) placing a mandatory Super Bonus bet on the occurrence of one of a predetermined plurality of winning poker hands; and c) a dealer dealing at least two hands of cards to the dealer position and a hand of cards to each player participating in the game.

U.S. Pat. No. 6,454,266 (Breeding, et al.) teaches a method of playing a wagering game that involves each player placing a multiple part bet, such as a two, a three or a four-part bet. At least one game symbol is designated as wild. A certain position in the order of play is reached (such as with cards being dealt by the dealer, two face down to the dealer and three face down to each player), and the player is given an opportunity to withdraw at least one part of the multiple part bet from risk.

U.S. Pat. No. 5,288,081 (Breeding) teaches a playing card wagering game method that involves each player placing a three part bet. Cards are dealt by the dealer, two face down to the dealer and three face down to each player. Players inspect or “sweat” their cards and the dealer gives each player the choice of withdrawing or leaving a first part of the bet. Each player decides and the dealer then turns over one of the cards and again gives each player the choice of withdrawing or leaving the second part of the bet. The players decide, their cards are shown, and all remaining bets, which were not withdrawn, are resolved.

Each of the references discussed in this text art are incorporated herein in their entirety for all purposes including enablement of multiplayer platforms and structures for execution of games according to the present invention.

It is still desirable to create a new and exciting three-card poker game that is not resolved against a dealer hand and that provides an extra level of anticipation by designating specific predetermined cards as wild cards.

### SUMMARY OF THE INVENTION

A method of playing a wagering card game comprised of a three-card hand for a single player or multiple players uses at least a three decks of 52 standard playing cards having a standard rank. All cards of a predetermined suit are designated as being special cards, and at least one special card is determined to be a wild card. A paytable is provided that is based on the amount of the special cards in each individual final hand. In an example, wherein all Hearts are special cards, the paytable is divided into four categories: No-Heart hands, 1-Heart hands, 2-Heart hands and 3-Heart hands. Each category has predetermined rules that designate which Hearts are wild therein. The composition of final winning hands is predetermined by category, and winning hands are paid in varying multiples of a wager.

The present invention requires an Ante wager from each player and is played with three cards dealt face up to each player. One community card is dealt face down to the dealer. Each player examines his three-card hand, and may decide to either: a) stand (ending the game), keeping the Ante wager and collecting any wins according to the paytable; b) fold (ending the game), losing the Ante wager; or c) continue play (continuing the game) by losing the Ante wager, making a Draw wager equal to the Ante wager, and indicating exactly one card to be replaced. If the player decides to c), continue play, the Ante wager and the one indicated card are removed from play. After all players have made their decisions, any players who have continued the game by making the Draw wager are provided with the community card that is revealed by the dealer to complete their hand. Hands are then resolved according to the same paytable. A side bet based on the initial and/or final hand and based on a either the same paytable or a separate paytable is also disclosed herein.

### BRIEF DESCRIPTION OF THE FIGURES

FIG. 1 shows a sample paytable for a first embodiment described herein.

FIG. 2 shows a graphic illustration of the game elements of the first embodiment.

FIG. 3 shows a first game of the first embodiment at a beginning stage.

FIG. 4 shows the first game of the first embodiment at a later stage.

FIG. 5 shows the first game of the first embodiment at a final stage.

FIG. 6 shows a second game of the first embodiment at a beginning stage.

FIG. 7 shows the second game of the first embodiment at a later stage.

FIG. 8 shows the second game of the first embodiment at a final stage.

FIG. 9 shows a third game of the first embodiment at a beginning stage.

FIG. 10 shows the third game of the first embodiment at a later stage.

FIG. 11 shows the third game of the first embodiment at a later stage.

FIG. 12 shows a sample paytable for the side bet.

### DETAILED DESCRIPTION OF THE INVENTION

A method of playing a wagering poker game uses at least three decks of 52 standard playing cards having thirteen ranks (2, 3, 4, 5, 6, 7, 8, 9, 10, J, Q, K, A) and four suits (Hearts, Diamonds, Spades, Clubs). The game is played on a felt table utilizing physical playing cards, or it may be an electronic game utilizing at least a computer processor, input device and a video monitor screen. The game may be played on at least a casino gaming table, a casino gaming machine, a personal computer or pad, an internet gaming site, or as a mobile application. In the case of a table game format, it is preferred the decks are shuffled by either an electronic shuffling machine or an electronic continuous shuffler, in order to provide a random deal of the cards and as a prevention to card-counting. An electronic format requires the use of a Random Number Generator, or RNG, in order to provide a random deal result.

The present invention comprises a poker game of preferably a three-card player hand, although hands of greater amounts of cards are within the scope thereof. The game is playable by a single player or multiple players. The game requires an Ante wager to play an initial hand, and at least one additional Draw wager if the play of the initial hand is continued. The initial hand is considered a final hand if it is resolved as a win or loss. If the initial hand is not resolved, play continues until a final hand is resolved. The game is resolved against a first predetermined paytable. At least four predetermined cards are special cards, and at least one special card acts as a wild card. The predetermined paytable is based on the amount of the special cards in a final hand. The amount of special cards in a final hand determines a category in the predetermined paytable. Each category has predetermined rules that designate which special cards are wild therein. The composition of any final winning hands is predetermined by category, and said winning final hands are paid in varying multiples of the wager(s). It is also contemplated that alternate payouts may be provided.

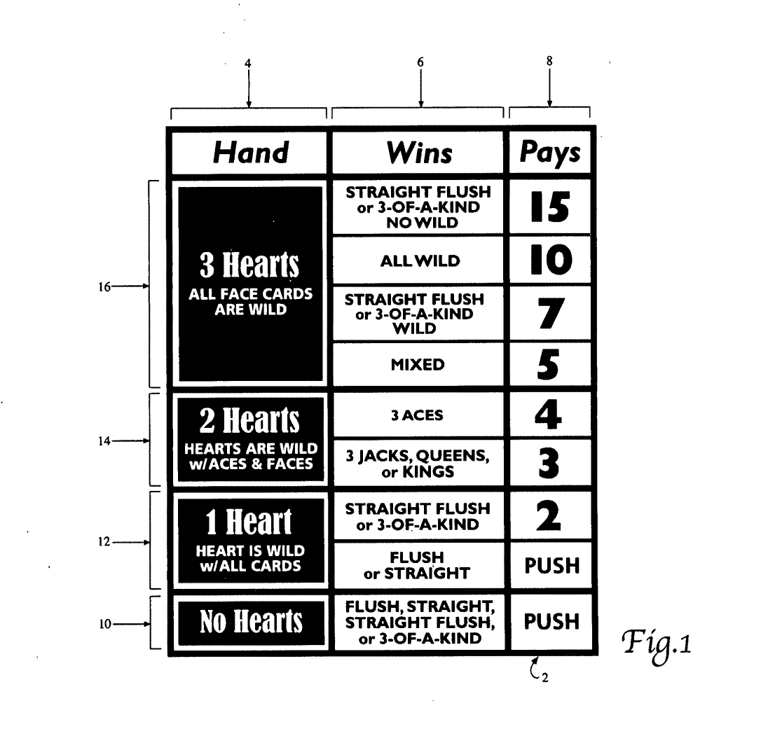

In a first embodiment of the present invention, a wagering card game is played utilizing from three to eight standard decks of cards. All Hearts (or any other one suit) are special cards that may be determined as wild cards. A predetermined paytable is provided that is based on the amount of the Hearts in an individual final hand. The paytable is divided into four categories: No-Heart hands, 1-Heart hands, 2-Heart hands and 3-Heart hands. Each category has predetermined rules that designate which Hearts are wild therein, and the composition of final winning hands according to the paytable is predetermined by category. In this said first embodiment and according to the sample first paytable in FIG. 1, three-card hands with no Hearts comprised of a Straight, Flush, Straight Flush or 3-of-a-Kind are considered a Push (the wager is not lost, but neither is there a win). In three-card hands comprising specifically one Heart (with two non-hearts), the one Heart is Wild; Flushes and Straights (Wild) are a Push, and Straight Flushes and 3-of-a-Kind (Wild) are paid 2× the wager. In three-card hands comprising specifically two Hearts (with one non-Heart), both Hearts are Wild if the non-Heart card is a Jack, Queen, King or Ace; three Jacks (Wild), Queens (Wild) or Kings (Wild) are paid 3× the wager, and three Aces (Wild) are paid 4× the wager. In three-card hands comprising all Hearts, Jacks, Queens and Kings are Wild; Mixed Hearts are paid 5× the wager, Straight Flushes (Wild) and 3-of-a-Kind (Wild) are paid 7× the wager, all Wild cards (any mix of Jacks, Queens, and Kings) are paid 10× the wager, and non-Wild Straight Flushes and 3-of-a-Kind are paid 15× the wager. Winning hands are preferably paid in varying multiples of a wager, although other payouts may be permitted.

Continuing the first embodiment, each player places an Ante wager (cash, credits, non-monetary points, etc.) on a first betting circle and is dealt three face-up cards by a physical dealer (or in the case of an electronic table, a virtual dealer, or in the case of an electronic game device, by the processor). One draw card is dealt face down to the dealer as a community card. After all player hands and the dealer hand have been dealt, each player examines his three-card hand, and may decide to either: a) stand (ending the game), keeping the Ante wager and collecting any wins according to the first predetermined paytable; b) fold (ending the game), losing the Ante wager; or c) continue play (continuing the game) by losing the Ante wager, making a Draw wager on a second betting circle equal to the Ante wager, and indicating exactly one card in his hand to be discarded. If the player decides to c), continue play, the Ante wager and the one indicated card are removed from play. After all players have made their decisions, any players who have continued the game by making the Draw wager are provided with the community card that is revealed by the dealer to complete their hand. (In an alternative method, a community card is not dealt; instead, each separate hand is provided a separate Draw card to complete that said hand.) Hands are then resolved according to the same first predetermined paytable. A side bet may be offered on the initial (or alternately, the final) hand that provides the same payouts of the first paytable.

It should be appreciated that the particular design and mathematical analysis of the game will dictate the actual rules for wagering, selecting the predetermined set of particular special cards, providing a wild conversion, specifying categories of hands, and the composition of winning hands that will provide a reasonable take for the house. It is within the scope of the present invention to: provide alternate wagering rules, including Ante wagers and Draw wagers that may or may not be equal, and alternate rules in resolving the wagers, whereby the Ante wager and/or the Draw wager may or may not be lost; select a predetermined set of special cards that may comprise at least four cards of at least one specific suit, at least four cards of at least one specific color, at least four cards of at least one specific rank, or any combination thereof; provide alternate Wild-conversion rules wherein at least one special card is converted to a Wild card; specify at least one category of hands; and specify at least one combination of cards in at least one category of hands to be is a winning hand according to the paytable.

It is contemplated that the poker game may in alternate embodiments have initial hands of at least three cards, and final hands of at least three cards. In particular, the game may be played with a) initial hands of four or more cards; b) initial hands of three cards that become hands of four cards wherein the Draw card does not replace a card in an initial hand, but rather is added to the initial hand; or c) initial hands of four or more cards wherein the Draw card may or may not replace a card in the initial hand.

It is also contemplated that the poker game may in alternate embodiments have a) more than one Draw card option wherein there may or may not be a required wager for each Draw card and b) a separate paytable for hands that comprise differing amounts of cards (i.e., one paytable for a three-card hand, a different paytable for a four-card hand, a yet different paytable for a five-card hand, etc.). It should be appreciated that any combination of the aforementioned alternate rules and embodiments are within the scope of the present invention.

It should be appreciated by one skilled in the art that depending on the final rules and mathematical analysis of the game, an optimum strategy for play decisions can be constructed. An example of an optimum play strategy according to the first embodiment of the present invention comprises: a) stand and keep all wins or pushes; or b) fold with a non-winning hand except: in a No-Heart hand, draw to a Straight Flush (outside or inside) or a suited Pair; in a 1-Heart hand, draw to one Heart with a Jack, Queen, King or Ace; in a 2-Heart hand, draw to two Hearts.

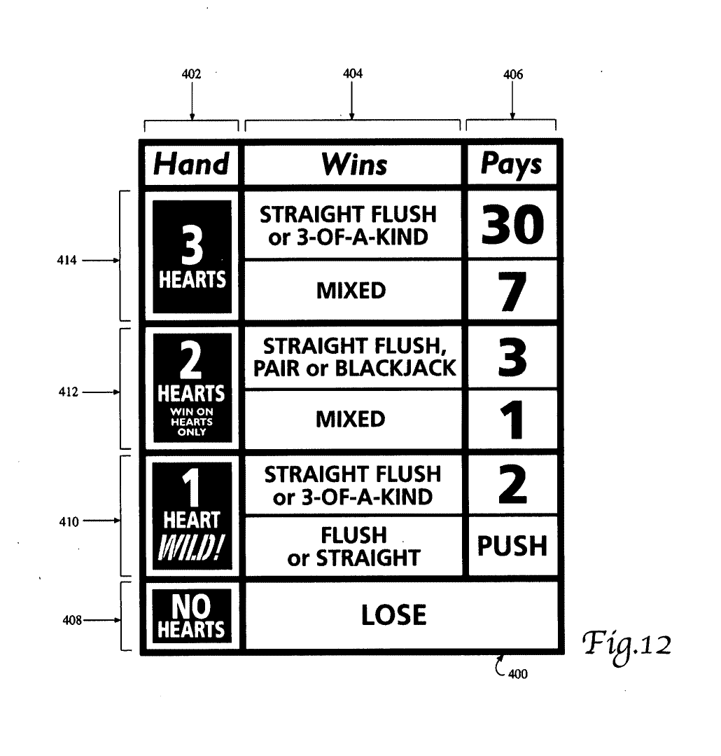

In a second embodiment of the present invention, a side bet is disclosed for a base game as disclosed in the first embodiment of the present invention. The side bet is a separate wager that may be made by the player in addition to the Ante wager (playing the base game), or in lieu of the Ante wager (not playing the base game). The side wager is based on the composition of the three cards in the initial hand (and/or the final draw hand) and resolved by a second paytable separate from the first paytable in the first embodiment of the present invention. The side bet paytable is divided into four categories: No-Heart hands, 1-Heart hands, 2-Heart hands and 3-Heart hands. Each category has predetermined rules that designate which Hearts are wild therein, and the composition of final winning hands according to the side bet paytable is predetermined by category. In this said second embodiment and according to the sample second paytable in FIG. 12, all three-card hands with no Hearts lose. In three-card hands comprising specifically one Heart (with two non-hearts), the one Heart is Wild; 3-card Flushes and Straights are a Push, and Straight Flushes and 3-of-a-Kind are paid 2× the wager. In three-card hands comprising specifically two Hearts (with one non-Heart), the pays are based on the make-up of the 2 Hearts only; a 2-card Hearts Flush or Straight is a Push and a 2-card Hearts Straight Flush, Pair or Blackjack [Ace with a 10-point card] are paid 3× the wager. In three-card hands comprising all Hearts, Mixed Hearts are paid 7× the wager, and Straight Flushes and 3-of-a-Kind are paid 30× the wager. Winning side bets are preferably paid in varying multiples of the side bet wager wherein the side bet wager is kept by the player, although other payouts may be permitted.

In a third embodiment of the present invention, a three-card wagering game is executed as in the first embodiment as an electronic game. The game is played on an electronic device comprising at least a processor, an input device and a monitor screen with virtual cards comprised of standard rank and suit symbols, with or without a virtual dealer. Special cards that are determined to be wild cards may be graphically altered to display a wild symbol in lieu of, or in addition to, the rank and suit symbols thereon. Potentially-wild cards may be depicted with blinking graphics, and actual wild cards may be depicted with solid graphics. For instance, according to the first paytable, if a player has an initial hand of 2 Hearts and a 3 of Spades, the 2 Hearts are not wild unless the third card is a non-Heart Face Card or Ace, or another Heart. The 2 Hearts would be displayed with a blinking Wild symbol, and if the player decides to Draw and receives a Face Card, the blinking Wild symbols would become solid Wild symbols. Also, the 2 Hearts would be displayed with a blinking Wild symbol, and if the player decides to Draw and receives another Heart, the blinking Wild symbols would become solid Wild symbols. If the Draw card is not a Face Card, Ace or Heart, the blinking Wild symbols would disappear. It should be appreciated by those skilled in the art that other means of displaying the Wild symbol may be desired.

The above embodiments provide the basis of the gameplay for both physical table games and electronic versions of the present invention. The various components of the electronic table or gaming machine are controlled by a central processing unit (CPU), also referred to herein as a controller or processor (such as a microcontroller or microprocessor). To provide gaming functions, the controller executes one or more game programs stored in a computer readable storage medium, in the form of memory. The controller performs the random selection using a random number generator (RNG) of an outcome from the plurality of possible outcomes of the wagering game. Alternatively, the random event may be determined at a remote controller. The remote controller may either use an RNG or a pooling scheme for its central determination of a game outcome. It should be noted that the controller may include one or more microprocessors, including, but not limited to, a master processor, a slave processor, and a secondary or parallel processor.

The controller is also coupled to the system memory and a money/credit detector. The system memory may comprise a volatile memory (e.g., a random-access memory [RAM]) and a non-volatile memory (e.g., an EPROM). The system memory may include multiple RAM and multiple program memories. The money/credit detector signals the processor that money and/or credits were input via the value input device. Preferably, these components are located within the housing of the gaming machine. However, as explained above, these components may be located outboard of the housing and connected to the remainder of the components of the gaming machine via a variety of different wired or wireless connection methods.

The controller is also connected to, and controls, the primary display, the player input device, and a payoff mechanism. The payoff mechanism is operable, in response to instructions from the controller, and awards a payoff to the player in response to certain winning outcomes that might occur in the basic game or the bonus game(s). The payoff may be provided in the form of points, bills, tickets, coupons, cards, etc. For example, the payoff mechanism may include both a ticket printer and a coin outlet. However, any of a variety of payoff mechanisms well known in the art may be implemented, including cards, coins, tickets, smartcards, cash, etc. One or more pay tables stored in the system memory determine the payoff amounts distributed by the payoff mechanism.

Communications between the controller and both the peripheral components of the gaming machine and external systems occur through input/output (I/O) circuits. More specifically, the controller directs and receives inputs from the peripheral components of the gaming machine through the input/output circuits. Further, the controller communicates with the external systems via the I/O circuits and a communication path (e.g., serial, parallel, IR, RC, 10bT, etc.). The external systems may include a gaming network, other gaming machines, a gaming server, communications hardware, or a variety of other interfaced systems or components. Even though the I/O circuits may be shown as a single block, it should be noted that each of the I/O circuits may include different types of I/O circuits.

Controller, as used herein, comprises any combination of hardware, software, and/or firmware that may be disposed or reside inside and/or outside the gaming machine that may communicate with and/or control the transfer of data between the gaming machine and a bus, another computer, processor, or device and/or a service and/or a network. The controller may comprise one or more controllers or processors. The controller may, alternatively, comprise a CPU in combination with other components, such as the I/O circuits and the system memory.

Reference to the Figures will assist in further understanding of the practice of the present invention.

FIG. 1 shows a sample payout table 2 according to the first embodiment of the present invention herein called HEARTS ON FIRE. Three columns are shown: a first column 4 comprising four hand categories; a second column 6 comprising specific card combinations that constitute winning hands per category; and a third column 8 comprising specific pay amounts for each winning hand. The pays are multiples of either the Ante wager or the Deal wager. The four hand categories are shown in rows. A first row 10 comprises three-card hands that do not contain any special cards (in this example, all Hearts are special cards). Winning hands with no Hearts comprise a flush, a straight, a straight flush or a 3-of-a-kind, with all winning hands receiving a Push. A second row 12 comprises three-card hands that contain 1 Heart that acts a Wild card with all other cards. Winning hands with 1 Heart that comprise a flush or a straight are considered a Push and a straight flush or a 3-of-a-kind are paid 2:1. A third row 14 comprises three-card hands that contain 2 Hearts that act as Wild cards with any face card (Jack, Queen or King) or Ace. Winning hands of 2 Hearts and a face card are paid 3:1, and winning hands of 2 Hearts and an Ace are paid 4:1. A fourth row 16 comprises three-card hands that contain all Hearts wherein all face cards are Wild. Winning hands of all mixed Hearts are paid 5:1, winning hands comprised of a straight flush (Wild) or a 3-of-a-kind (Wild) are paid 7:1, winning hands comprised of all Wild cards are paid 10:1, and winning hands comprised of a straight flush (no Wild) or a 3-of-a-kind (no Wild) are paid 15:1.

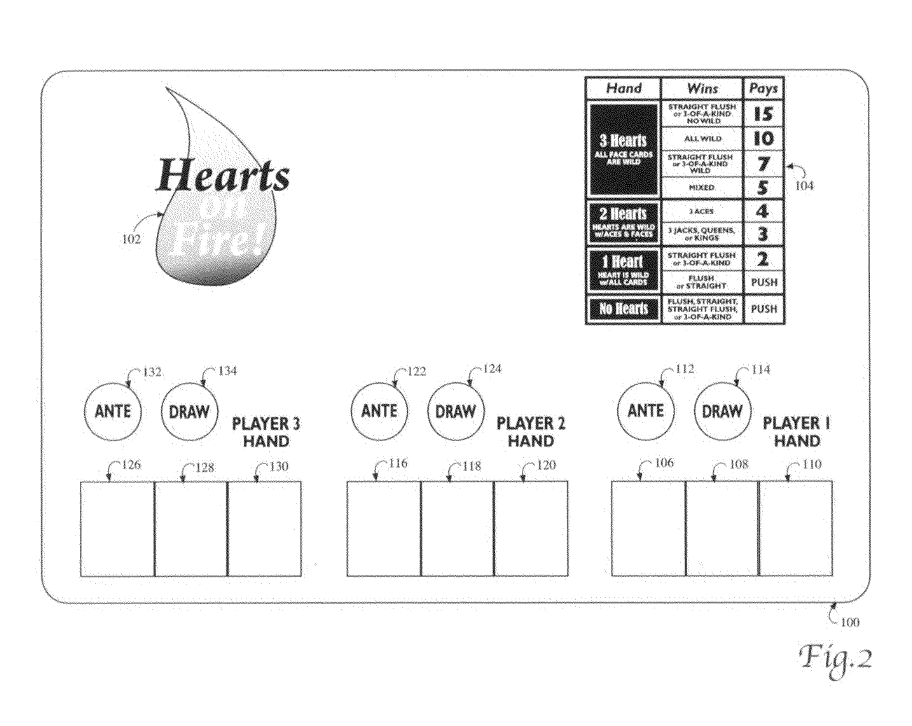

FIG. 2 shows a felt table layout (or alternately a player monitor screen) 100 according to the first embodiment of the present invention, displaying the name 102 and the paytable of FIG. 1 104 for a three-card poker game. Shown are three player hand areas comprising: a player card area for Player 1 comprising an area for a first card 106, a second card 108 and a third card 110 with an Ante Betting Circle area 112 and a Draw Betting Circle area 114; a player card area for Player 2 comprising an area for a first card 116, a second card 118 and a third card 120 with an Ante Betting Circle area 122 and a Draw Betting Circle area 124; a player card area for Player 3 comprising an area for a first card 126, a second card 128 and a third card 130 with an Ante Betting Circle area 132 and a Draw Betting Circle area 134.

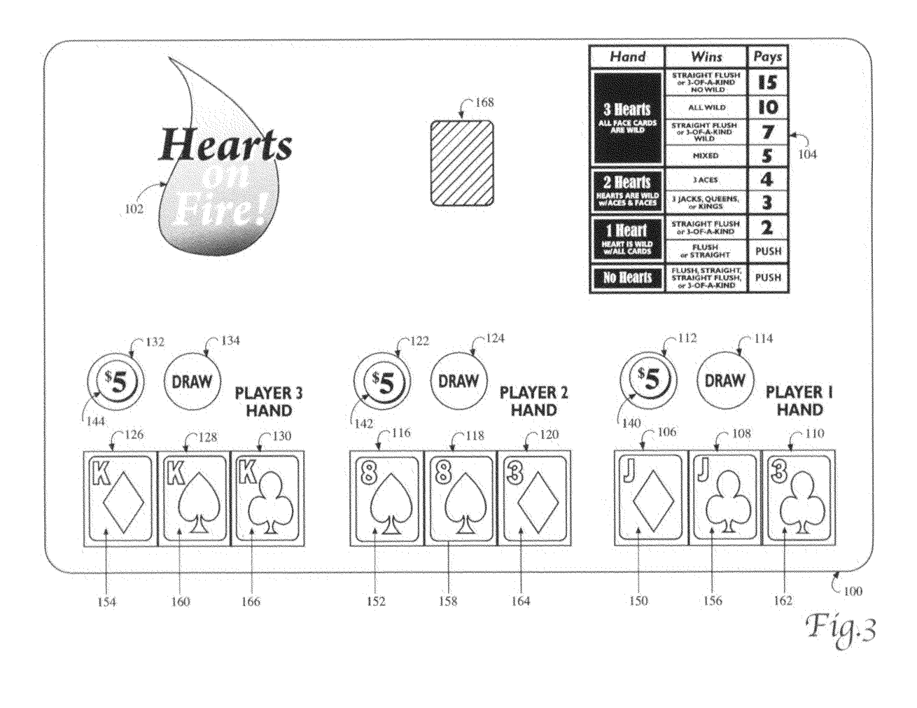

FIG. 3 refers to the elements in FIG. 2 wherein all three players, from Player 1 through Player 3, in ascending order have placed a $5 Ante wager (140, 142, 144). The deal of three-card poker is first executed wherein Player 1 receives his first card 150 (a Jack of Diamonds), Player 2 receives his first card 152 (an 8 of Spades), and Player 3 receives his first card 154 (a King of Diamonds). The deal is continued with Player 1 receiving his second card 156 (a Jack of Clubs), Player 2 receiving his second card 158 (an 8 of Spades), and Player 3 receiving his second card 160 (a King of Spades). The deal is further continued with Player 1 receiving his third card 162 (a 3 of Clubs), Player 2 receiving his third card 164 (a 3 of Diamonds), and Player 3 receiving his third card 166 (a King of Clubs). The dealer then receives a face-down card 168 to be used as a community card. All three players have randomly received hands containing No Hearts.

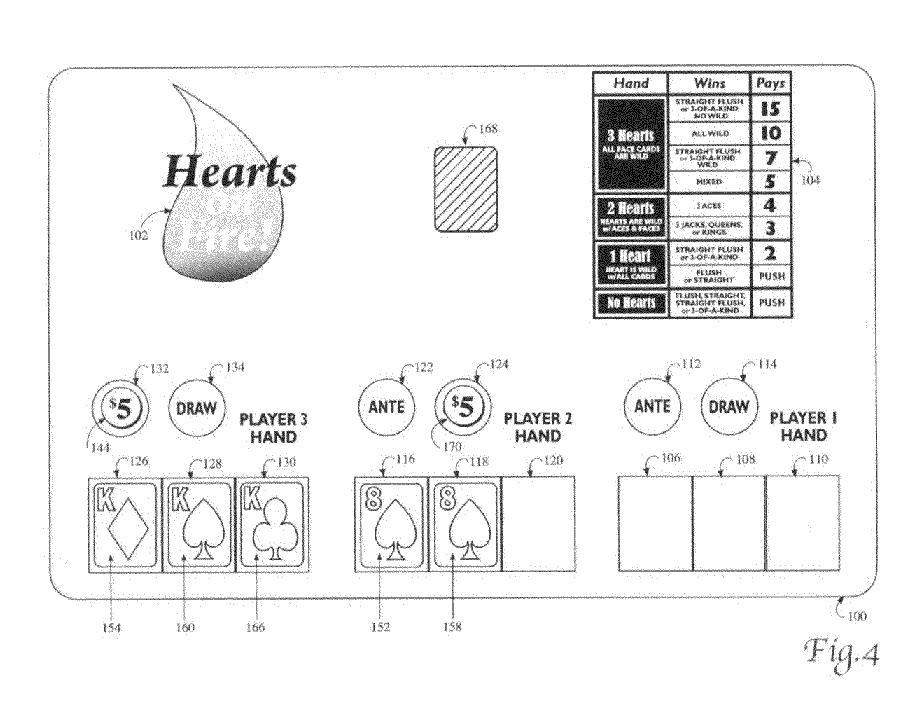

FIG. 4 refers to the elements in FIG. 3 with: Player 1 folding his hand according to the strategy described in the first embodiment herein, losing his Ante wager according to the paytable 104 and with the cards in his hand being removed; Player 2 continuing his game according to the strategy described in the first embodiment herein by losing his Ante wager, making a $5 Draw wager 170, and electing to discard his third card in card area 120; and Player 3 standing according to the strategy described in the first embodiment herein with a pat hand of 3-of-a-Kind. Player 3's hand is a Push according to the paytable 104, and his cards will be removed before the Draw.

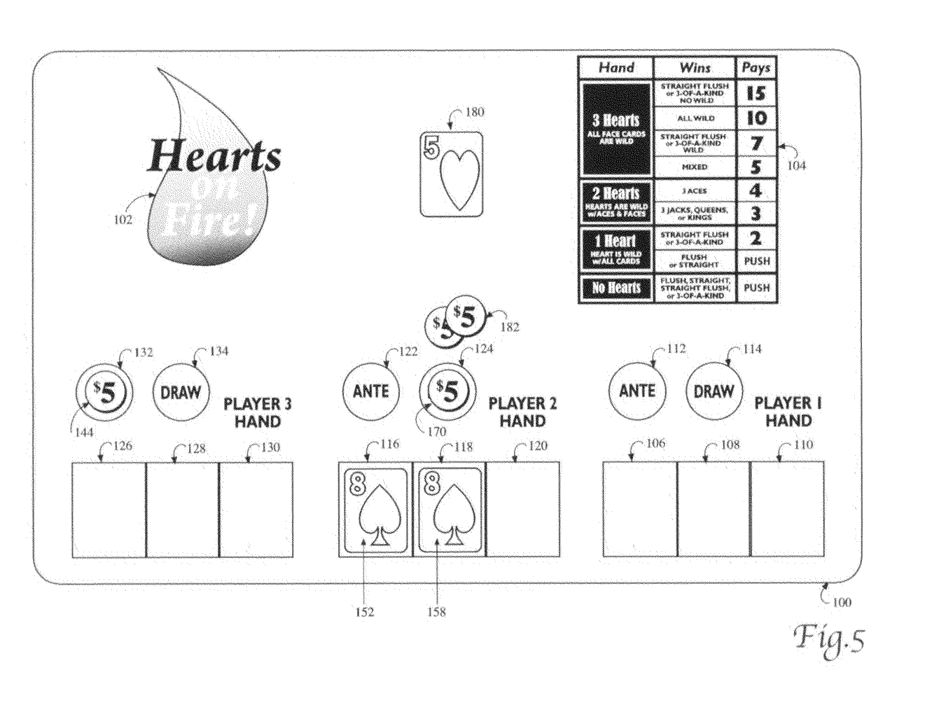

FIG. 5 refers to the elements in FIG. 4 with the dealer revealing the community card 180 (a 5 of Hearts). The community card completes Player 2's hand, providing a 3-of-a-Kind with 1 Heart (as a Wild card), with Player 2 winning $10 182 on his Draw wager according to the paytable 104.

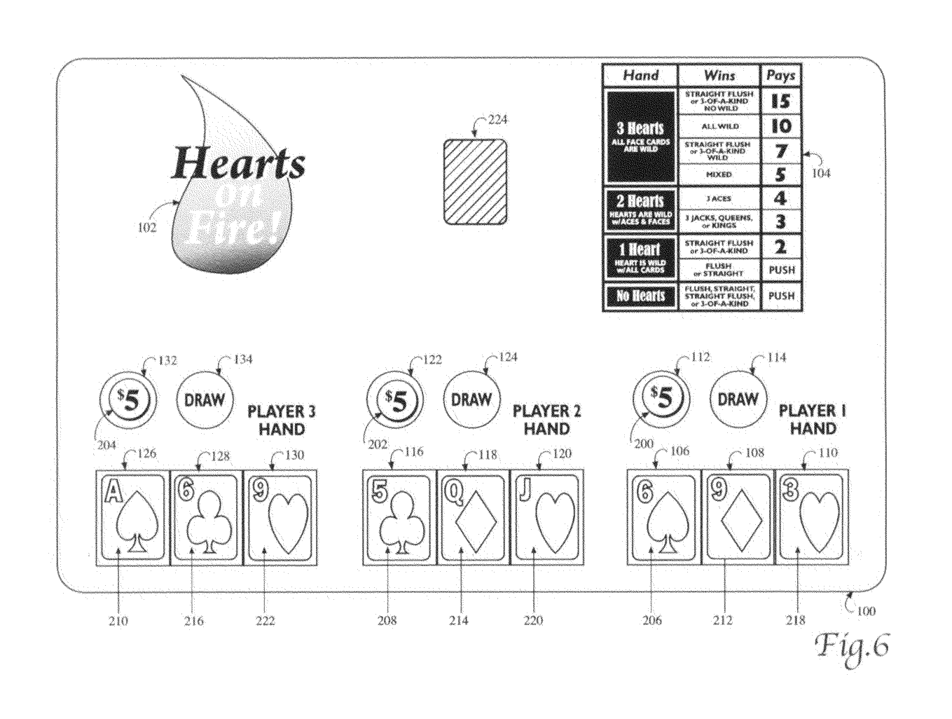

FIG. 6 shows the felt table layout (or alternately a player monitor screen) 100 with a second three-card game according to the first embodiment of the present invention, and according to the elements in FIG. 2. All three players, from Player 1 through Player 3, in ascending order have placed a $5 Ante wager (200, 202, 204). The deal is first executed wherein Player 1 receives his first card 206 (a 6 of Spades), Player 2 receives his first card 208 (a 5 of Clubs), and Player 3 receives his first card 210 (an Ace of Spades). The deal is continued with Player 1 receiving his second card 212 (a 9 of Diamonds), Player 2 receiving his second card 214 (a Queen of Diamonds), and Player 3 receiving his second card 216 (a 6 of Clubs). The deal is further continued with Player 1 receiving his third card 218 (a 3 of Hearts), Player 2 receiving his third card 220 (a Jack of Hearts), and Player 3 receiving his third card 222 (a 9 of Hearts). The dealer then receives a face-down card 224 to be used as a community card. All three players have randomly received hands containing 1 Heart.

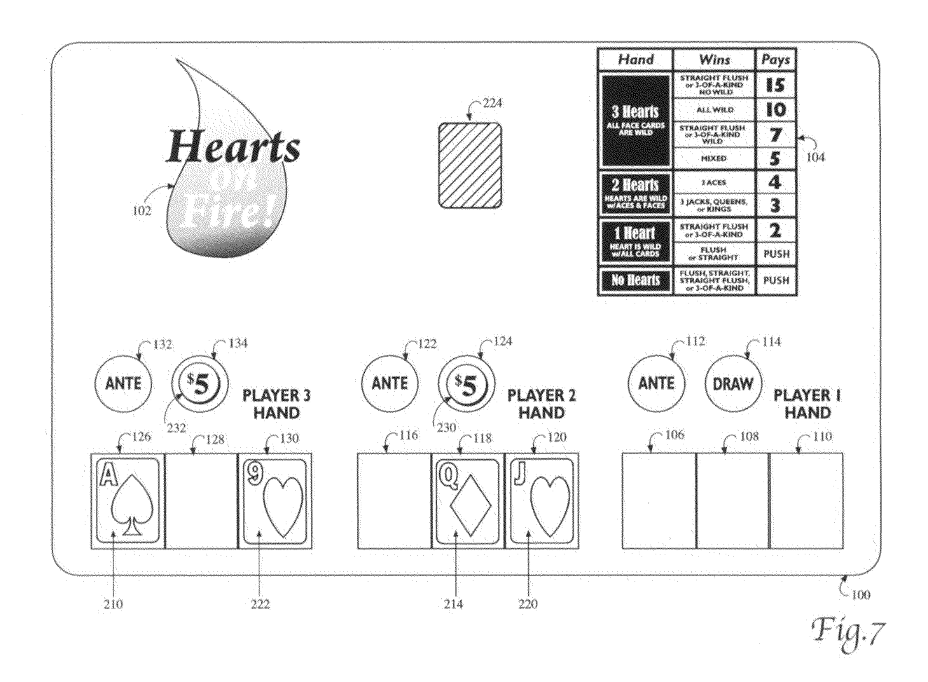

FIG. 7 refers to the elements in FIG. 6 with: Player 1 folding his hand according to the strategy described in the first embodiment herein, losing his Ante wager according to the paytable 104 and with the cards in his hand being removed; Player 2 continuing his game according to the strategy described in the first embodiment herein by losing his Ante wager, making a $5 Draw wager 230, and electing to discard his first card in card area 116; and Player 3 continuing his game according to the strategy described in the first embodiment herein by losing his Ante wager, making a $5 Draw wager 232, and electing to discard his second card in card area 128.

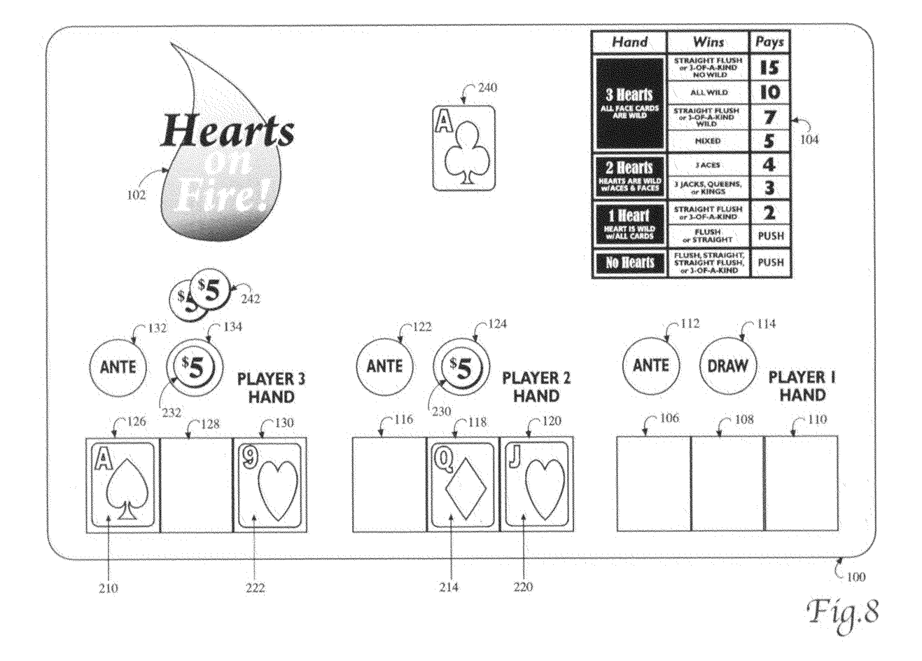

FIG. 8 refers to the elements in FIG. 7 with the dealer revealing the community card 240 (an Ace of Clubs). The community card completes Player 2's hand, providing a Straight (Q-K-A) with the Jack of Hearts acting as a Wild card, with Player 2 getting a Push according to the paytable 104. The community card also completes Player 3's hand, providing a 3-of-a-Kind with the 9 of Hearts acting as a Wild card, with Player 3 winning $10 242 on his Draw wager according to the paytable 104.

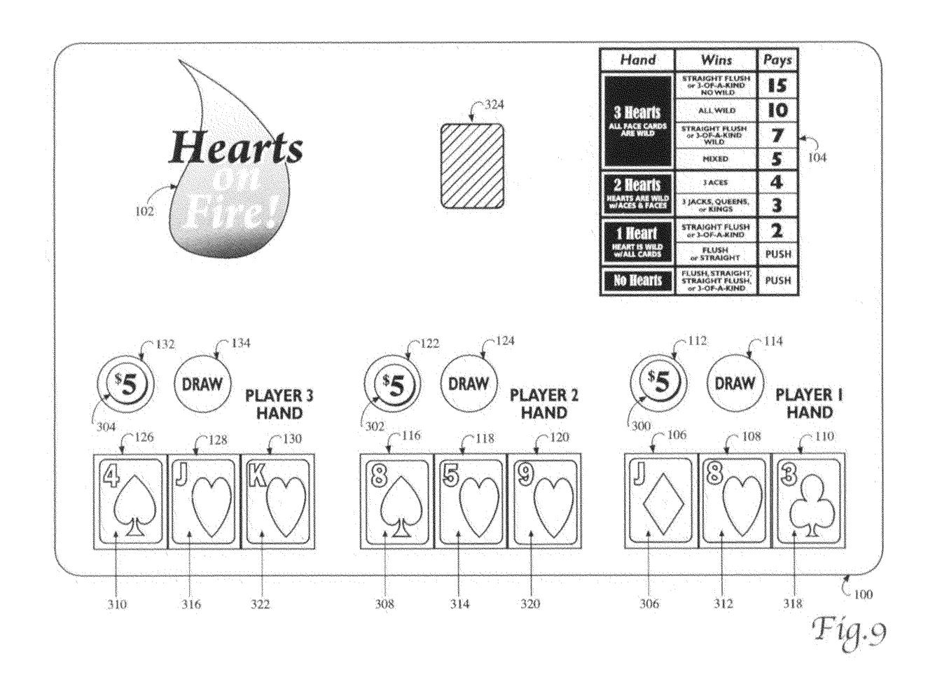

FIG. 9 shows the felt table layout (or alternately a player monitor screen) 100 with a third three-card game according to the first embodiment of the present invention, and according to the elements in FIG. 2. All three players, from Player 1 through Player 3, in ascending order have placed a $5 Ante wager (300, 302, 304). The deal is first executed wherein Player 1 receives his first card 306 (a Jack of Diamonds), Player 2 receives his first card 308 (an 8 of Spades), and Player 3 receives his first card 310 (a 4 of Spades). The deal is continued with Player 1 receiving his second card 312 (an 8 of Hearts), Player 2 receiving his second card 314 (a 5 of Hearts), and Player 3 receiving his second card 316 (a Jack of Hearts). The deal is further continued with Player 1 receiving his third card 318 (a 3 of Clubs), Player 2 receiving his third card 320 (a 9 of Hearts), and Player 3 receiving his third card 322 (a King of Hearts). The dealer then receives a face-down card 324 to be used as a community card.

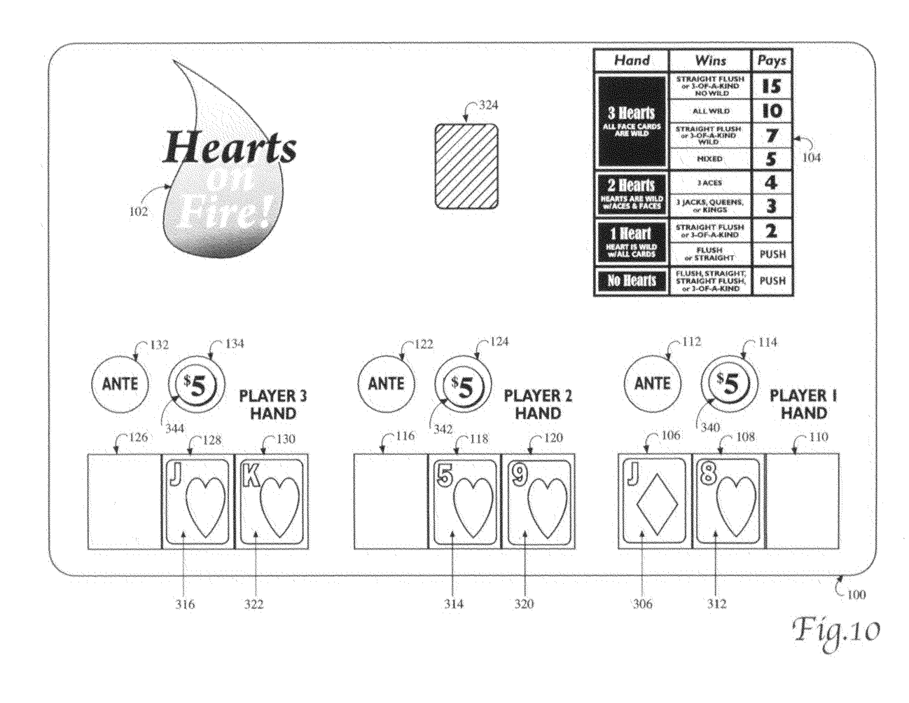

FIG. 10 refers to the elements in FIG. 9 with: Player 1 continuing his game according to the strategy described in the first embodiment herein by losing his Ante wager, making a $5 Draw wager 340, and electing to discard his third card in card area 110; Player 2 continuing his game according to the strategy described in the first embodiment herein by losing his Ante wager, making a $5 Draw wager 342, and electing to discard his first card in card area 116; and Player 3 continuing his game according to the strategy described in the first embodiment herein by losing his Ante wager, making a $5 Draw wager 344, and electing to discard his first card in card area 126.

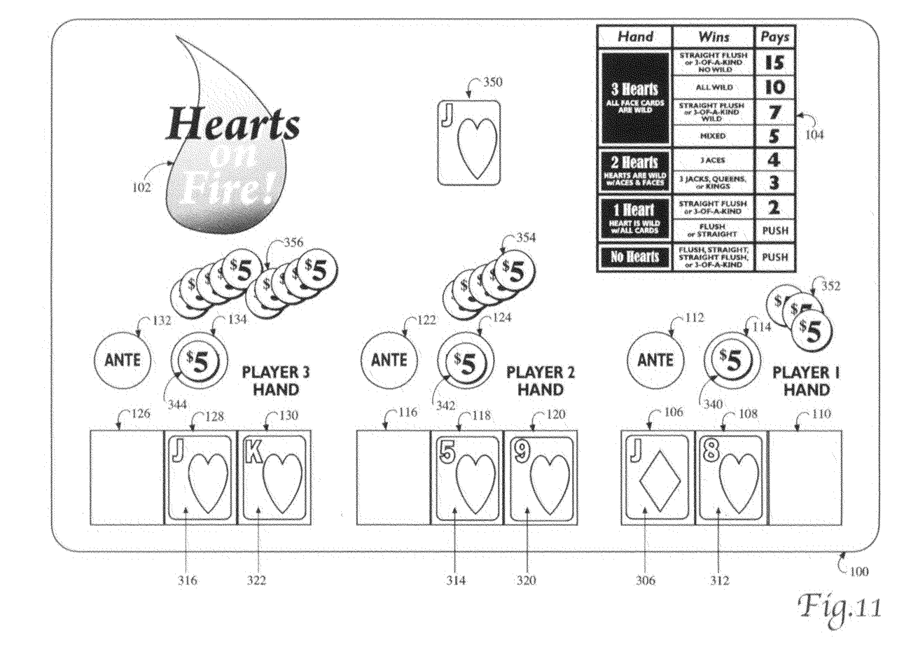

FIG. 11 refers to the elements in FIG. 10 with the dealer revealing the community card 350 (a Jack of Hearts). The community card completes Player 1's hand, providing a 3 Jacks hand (J-J-J) wherein both Hearts are Wild, with Player 1 winning $15 352 on his Draw wager according to the paytable 104. The community card also completes Player 2's hand, providing a Mixed hand of 3 Hearts, with Player 2 winning $25 354 on his Draw wager according to the paytable 104. The community card also completes Player 3's hand, providing a hand of All Wild Hearts, with Player 3 winning $50 356 on his Draw wager according to the paytable 104.

FIG. 12 shows a sample payout table 400 for a side bet based on the player's initial three-card hand according to the second embodiment of the present invention herein called HEARTS ON FIRE. Three columns are shown: a first column 402 comprising four hand categories; a second column 404 comprising specific card combinations that constitute winning hands per category; and a third column 406 comprising specific pay amounts for each winning hand. The pays are multiples of the side bet. The four hand categories are shown in rows. A first row 408 comprises three-card hands that do not contain any special cards (in this example, all Hearts are special cards). All hands with no Hearts lose. A second row 410 comprises three-card hands that contain 1 Heart that acts as a Wild card with all other cards. Winning hands with 1 Heart that comprise a flush or a straight are considered a Push and a straight flush or a 3-of-a-kind are paid 2:1. A third row 412 comprises three-card hands that contain 2 Hearts wherein only the 2 Hearts are eligible for wins. Winning hands containing exactly 2 mixed Hearts are paid 1:1, and winning hands containing exactly 2 Hearts comprising a 2-card straight flush, a 2-card pair or a 2-card blackjack (an Ace with a 10, Jack, Queen or King) are paid 3:1. A fourth row 414 comprises three-card hands that contain all Hearts. Winning hands of all mixed Hearts are paid 7:1, and winning hands comprised of a straight flush or a 3-of-a-kind are paid 30:1.

Although specific examples and specific rules have been provided in this discussion, these specifics are intended to be only support for the generic concepts of the invention and are not intended to be absolute limits in the scope of the technology discussed.

What is claimed:

1. A method of playing a wagering playing card game for at least one player comprising steps to:
a) establish an initial deck of physical playing cards comprised of standard ranks and suits to be used in the play of a three-card poker game on a physical gaming table;
b) provide predetermined rules wherein at least four predetermined cards are defined as special cards;
c) establish a predetermined first payout table associated with the three-card poker game wherein the amount of special cards in a player hand defines a pay category;
d) define at least one of the at least four special cards as a Wild card in each pay category if there is at least one special card in the pay category;
e) establish at least one predetermined card combination in each pay category as a winning final hand;
f) enable a player to make an Ante wager on an initial three-card poker hand by placing the wager on a first betting circle;
g) display to the player three cards face up representing the initial poker hand;
h) display to a dealer one card face down representing a Draw card;
i) enable the player to either 1) fold the initial hand; 2) stand on the initial hand; or 3) discard an exactly one card in the initial hand and replace the exactly one card with the Draw card;
j) define the initial hand as a final hand if the player elects to fold or stand;
k) resolve the final folding or standing hand according to the first predetermined paytable;
l) enable the player to make a Draw wager by placing the wager on a second betting circle if the player elects to discard the exactly one card in the initial hand and replace the exactly one card with the Draw card;
m) reveal the Draw card as a community card;
n) replace the exactly one discarded card in the initial hand with the revealed community card to form a final Draw hand; and
o) resolve the final Draw hand according to the first predetermined paytable.

2. The method of claim 1 wherein the initial deck of playing cards comprises at least three decks of physical traditional playing cards.

3. The method of claim 1 wherein the special cards comprise either a) at least one predetermined suit; b) at least one specific predetermined rank; or c) at least one predetermined color.

4. The method of claim 1 wherein the Draw wager may be less than, more than, or equal to the Ante wager and wherein the Ante wager and/or the Draw wager may be forfeited whether or not the final hand is a winning hand.

5. The method of claim 1 wherein the Draw card is dealt from the initial deck directly into the player hand.

6. The method of claim 1 wherein the Draw hand is resolved according to a second predetermined paytable.

7. The method of claim 1 wherein the Draw card is added to the initial hand instead of replacing a card in the initial hand and wherein the game is resolved according to a predetermined paytable differing from the first paytable.

8. The method of claim 1 wherein the card game is played with an initial hand comprising more than three cards.

9. A gaming system comprising: at least one processor; a gaming apparatus having at least one input device and at least one display device; at least one memory device which stores a plurality of instructions which, when executed by the at least one processor, cause the at least one processor to operate with the at least one display device and the at least one input device to:
a) establish an initial deck of virtual playing cards comprised of standard ranks and suits to be used in the play of a three-card poker game on the at least one display device;
b) provide predetermined rules wherein at least four predetermined cards are defined as special cards;
c) establish a predetermined first payout table associated with the three-card poker game wherein the amount of special cards in a player hand defines a pay category;
d) define at least one of the at least four special cards as a Wild card in each pay category if there is at least one special card in the pay category;
e) establish at least one predetermined card combination in each pay category as a winning final hand;
f) enable a player to make an Ante wager on an initial three-card poker hand;
g) display to the player three cards face up representing the initial poker hand;
h) display to a dealer one card face down representing a Draw card;
i) enable the player to either 1) fold the initial hand; 2) stand on the initial hand; or 3) discard an exactly one card in the initial hand and replace the exactly one card with the Draw card;
j) define the initial hand as a final hand if the player elects to fold or stand;
k) resolve the final folding or standing hand according to the first predetermined paytable;
l) enable the player to make a Draw wager if the player elects to discard the exactly one card in the initial hand and replace the exactly one card with the Draw card;
m) reveal the Draw card as a community card;
n) replace the exactly one discarded card in the initial hand with the revealed community card to form a final Draw hand; and
o) resolve the final Draw hand according to the first predetermined paytable.

10. The method of claim 9 wherein the initial deck of virtual playing cards comprises at least three decks.

11. The method of claim 9 wherein the special cards comprise either a) at least one predetermined suit; b) at least one predetermined rank; or c) at least one predetermined color.

12. The method of claim 9 wherein the Wild cards may be graphically altered to indicate the wild status of the said Wild cards.

13. The method of claim 9 wherein the Draw wager may be less than, more than, or equal to the Ante wager and wherein the Ante wager and/or the Draw wager may be forfeited whether or not the final hand is a winning hand.

14. The method of claim 9 wherein the Draw card is dealt from the initial deck directly into the player hand.

15. The method of claim 9 wherein the Draw hand is resolved according to a second predetermined paytable.

16. The method of claim 9 wherein the community card is added to the initial hand instead of replacing a card in the initial hand and wherein the game is resolved according to a predetermined paytable differing from the first paytable.

17. The method of claim 9 wherein the card game is played with an initial hand comprising more than three cards.

18. A method of providing a side bet for a wagering card game that is played with at least three predetermined decks of traditional playing cards, the side bet being placed by an at least one player with or without an Ante wager.

19. The method of claim 18 wherein the resolution of the side bet is based on at least four cards being predetermined as special cards according to suit, rank and/or color, and at least one said special card being predetermined to be a Wild Card.

20. The method of claim 19 wherein a predetermined paytable for the side bet is based on categories which are defined by the amount of special cards in the player's initial or final hand.
